(19) United States
(12) Patent Application Publication
(10) Pub. No.: US 2018/0107712 A1
(43) Pub. Date: Apr. 19, 2018

(54) ADAPTIVE QUERY ROW SELECTION

(71) Applicant: International Business Machines Corporation, Armonk, NY (US)

(72) Inventors: Craig S. ALDRICH, Rochester, MN (US); Rafal P. KONIK, Oronoco, MN (US); Roger A. MITTELSTADT, Byron, MN (US); Brian R. MURAS, Otsego, MN (US); Jane A. VOLD, Byron, MN (US)

(21) Appl. No.: 15/293,160

(22) Filed: Oct. 13, 2016

(51) Int. Cl. G06F 17/30

(52) U.S. Cl. CPC G06F 17/30463; G06F 17/30448; G06F 17/30477

(57) ABSTRACT

Techniques are described for managing exceptions occurring during query execution. Embodiments receive, from a requesting entity, a query for execution against a database. A first query plan for executing the query is generated, where the query plan comprises a first ordered sequence of operations to be performed in executing the query against the database. Embodiments determine a likelihood that the first query plan, if executed, will result in one or more exceptions being thrown and dynamically modify the first query plan based on the determined likelihood. The modified first query plan is executed against the database to produce a set of query results and the set of query results is returned to the requesting entity.

### BACKGROUND

The invention relates to database management systems, and in particular, to managing exceptions occurring during query execution using adaptive query row selection.

Databases are used to store information for an innumerable number of applications, including various commercial, industrial, technical, scientific and educational applications. As the reliance on information increases, both the volume of information stored in most databases, as well as the number of users wishing to access that information, likewise increases. Moreover, as the volume of information in a database, and the number of users wishing to access the database, increases, the amount of computing resources required to manage such a database increases as well.

Database management systems (DBMS's), which are the computer programs that are used to access the information stored in databases, therefore often require tremendous resources to handle the heavy workloads placed on such systems. As such, significant resources have been devoted to increasing the performance of database management systems with respect to processing searches, or queries, to databases.

Improvements to both computer hardware and software have improved the capacities of conventional database management systems. For example, in the hardware realm, increases in microprocessor performance, coupled with improved memory management systems, have improved the number of queries that a particular microprocessor can perform in a given unit of time. Furthermore, the use of multiple microprocessors and/or multiple networked computers has further increased the capacities of many database management systems.

From a software standpoint, the use of relational databases, which organize information into formally-defined tables consisting of rows and columns, and which are typically accessed using a standardized language such as Structured Query Language (SQL), has substantially improved processing efficiency, as well as substantially simplified the creation, organization, and extension of information within a database. Furthermore, significant development efforts have been directed toward query “optimization”, whereby the execution of particular searches, or queries, is optimized in an automated manner to minimize the amount of resources required to execute each query.

### SUMMARY

According to one embodiment, a method includes receiving, from a requesting entity, a query for execution against a database. The method also includes generating a first query plan for executing the query, where the query plan comprises a first ordered sequence of operations to be performed in executing the query against the database. The method additionally includes determining a likelihood that the first query plan, if executed, will result in one or more exceptions being thrown. The method further includes dynamically modifying the first query plan based on the determined likelihood. Moreover, the method includes executing the modified first query plan against the database to produce a set of query results, and returning the set of query results to the requesting entity.

According to another embodiment, a system includes one or more computer processors and a memory containing computer program code that, when executed by operation of the one or more computer processors, performs an operation that includes receiving, from a requesting entity, a query for execution against a database. The operation also includes generating a first query plan for executing the query, where the query plan comprises a first ordered sequence of operations to be performed in executing the query against the database. The operation additionally includes determining a likelihood that the first query plan, if executed, will result in one or more exceptions being thrown. The operation further includes dynamically modifying the first query plan based on the determined likelihood. Moreover, the operation includes executing the modified first query plan against the database to produce a set of query results, and returning the set of query results to the requesting entity.

Another embodiment provides a computer-readable storage medium containing computer program code that, when executed by operation of one or more computer processors, performs an operation that includes receiving, from a requesting entity, a query for execution against a database. The operation also includes generating a first query plan for executing the query, where the query plan comprises a first ordered sequence of operations to be performed in executing the query against the database. The operation additionally includes determining a likelihood that the first query plan, if executed, will result in one or more exceptions being thrown. The operation further includes dynamically modifying the first query plan based on the determined likelihood. Moreover, the operation includes executing the modified first query plan against the database to produce a set of query results, and returning the set of query results to the requesting entity.

### BRIEF DESCRIPTION OF THE SEVERAL VIEWS OF THE DRAWINGS

FIG. 1 is a block diagram illustrating a database system configured with a query management component, according to one embodiment described herein.

FIG. 2 is a flow diagram for processing a database query, according to one embodiment described herein.

FIG. 3 illustrates a query being processed by a query management component, according to one embodiment described herein.

FIG. 4 is a flow diagram illustrating a method of modifying a query to prevent exceptions from being thrown during the execution of a query, according to one embodiment described herein.

FIG. 5 is a flow diagram illustrating a method of selectively modifying a query to prevent exceptions from being thrown during the execution of a query, according to one embodiment described herein.

### DETAILED DESCRIPTION

Typically, executing a database query involves performing a set of input and output operations (e.g., on a database table). Moreover, in executing a database query, one or more data processing operations can be performed on values retrieved from the database (e.g., a division operation could be performed using one or more values retrieved from a column within a table of the database). In doing so, data mapping errors can occurring during the execution of the query. For example, an exception could be thrown during the processing of a particular database table, and such an exception in a conventional DBMS could result in the termination of the read/write buffer processing for the table (as well as an error message being returned to the DBMS and, potentially, to the client submitting the database query).

Generally, such an exception could be thrown for a variety of reasons. For example, a database table being accessed by the query could contain bad data (e.g., misformed data), such as an improperly formed data field (e.g., a data value having an improper format for a date field, a data value having values outside of the fixed range for a date field, character data values being written to a decimal data type field, etc.). As another example, a data processing operation performed in executing the query could result in the exception being thrown. For instance, a query could specify that a division operation should be performed using values retrieved from a particular database column, and such a database column could contain one or more values that result in an exception being thrown. As an example, a query of “SELECT 10/FLD1 FROM TBL1”, where FLD1 contains a zero value, could result in a division by zero operation being performed, which in turn could result in an exception being thrown during the execution of the query. As an additional example, a query could result in a mathematic overflow error which in turn could result in one or more exceptions being thrown during the execution of the query.

In practice, such exceptions being thrown during query execution can result in reduced performance of an application that is submitting the query to the DBMS, as well as one or more error messages being displayed during the execution of the application. Such errors can result in customer complaints, problem management reports (PMRs) being submitted), and discussion items (DIs) being created for data mapping or selection errors (e.g., where the customer did not receive such errors in a previous release of the DBMS, or when the errors otherwise seem to appear without a reason). While such errors can appear to arise suddenly and to be indicative of a problem with the DBMS itself, many times these errors are actually caused by misformed or otherwise erroneous data within the database itself, rather than a problem with the DBMS.

Additionally, in many instances, a set of query results may include only a few erroneous values, while the vast majority of the values within the query results may be valid. In conventional systems, an error occurring during the processing of any of the query result rows (e.g., an exception being thrown when attempting to generate a particular query result row) can terminate the execution of the query altogether, and the DBMS can return an error message to the party submitting the query, in lieu of any query results. However, in many instances, a user may be willing to accept a partial set of query results that includes only the non-erroneous query result rows.

As such, embodiments provide techniques for managing the execution of a query in a manner that accounts for an exception being thrown during execution of the query. In one embodiment, a DBMS configured with a query management component receives, from a requesting entity, a query for execution against a database. The DBMS generates a first query plan for executing the query. Generally, the query plan specifies a first ordered sequence of operations to be performed in executing the query against the database. The query management component could determine a likelihood that the first query plan, if executed, will result in one or more exceptions being thrown, and the query management component could modify the first query plan based on the determined likelihood. The DBMS could then execute the modified first query plan against the database to produce a set of query results and could return the set of query results to the requesting entity.

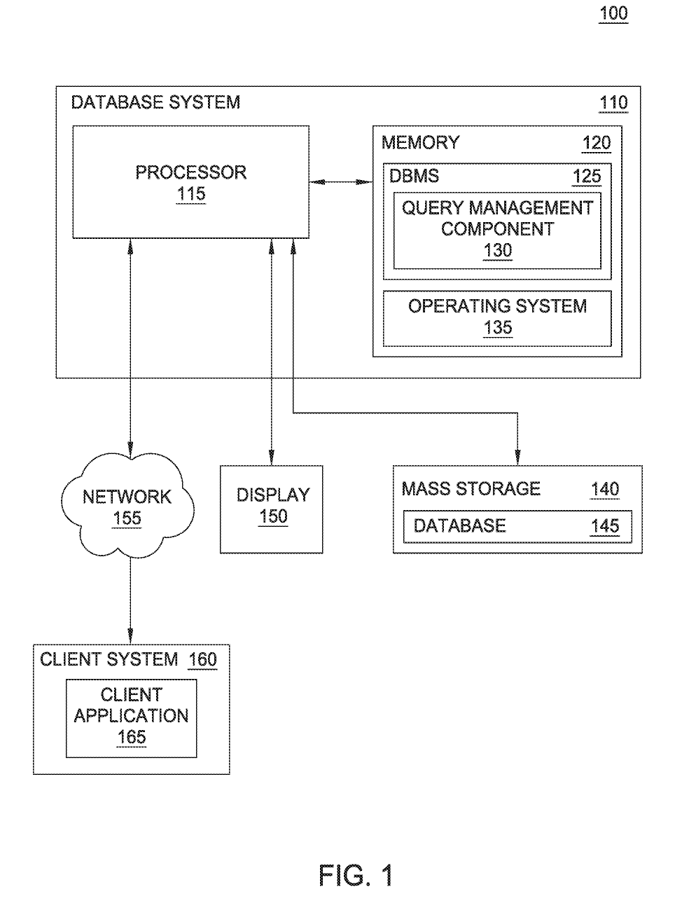

FIG. 1 is a block diagram illustrating a database system configured with a query management component, according to one embodiment described herein. Generally, system 100 represents practically any type of computer, computer system or other programmable electronic device, including a client computer, a server computer, a portable computer, a handheld computer, an embedded controller, etc. Moreover, the system 100 may be implemented using one or more networked computers, e.g., in a cluster or other distributed computing system.

System 100, as shown, includes a database system 110 and a client system 160, interconnected via network 155. The client system 160 includes a client application 165. Additionally, database system 110 is communicatively coupled to a display device 150 and a mass storage device 140. The database system 110, as shown, includes at least one processor 115 coupled to a memory 120. Processor 115 may represent one or more processors (e.g., microprocessors), and memory 120 may represent the random access memory (RAM) devices comprising the main storage of the database system 110, as well as any supplemental levels of memory, e.g., cache memories, non-volatile or backup memories (e.g., programmable or flash memories), read-only memories, etc. In addition, memory 120 may be considered to include memory storage physically located elsewhere in system 100, e.g., any cache memory in a processor 115, as well as any storage capacity used as a virtual memory, e.g., as stored on a mass storage device 140 or on another computer coupled to system 100 via network 155 (e.g., a client computer 160).

Generally, the database system 110 typically receives a number of inputs and outputs for communicating information externally. For interface with a user or operator, the database system 110 typically includes one or more user input devices (e.g., a keyboard, a mouse, a trackball, a joystick, a touchpad, and/or a microphone, among others) and provides a graphical user interface via display device 150 (e.g., a CRT monitor, an LCD display panel, among others). Otherwise, user input may be received via another computer interfaced with the database system 110 (e.g., over network 155), or via a dedicated workstation interface or the like.

For additional storage, the database system 110 is configured to interface with mass storage device 140, e.g., a hard disk drive, a direct access storage device (DASD), an optical drive (e.g., a CD drive, a DVD drive, etc.), and/or a tape drive, among others. The network 155 generally represents any data communications network (e.g., a LAN, a WAN, a wireless network, and/or the Internet, among others) and generally permits electronic communication of information between the database system 110 and other computers coupled to the network 155 (e.g., client system 160). It should be appreciated that database system 110 may also include suitable analog and/or digital interfaces (not shown) between processor 115 and each of components (e.g., network 155, display 150, etc.).

As shown, the memory 120 includes a Database Management System (DBMS) 125 and an operating system 135. Generally, the database system 110 operates under the control of the operating system 135, and executes or otherwise relies upon various computer software applications, components, programs, objects, modules, data structures, etc. The DBMS 125 is configured with a query management component 130. Generally, the DBMS 125 facilitates the creation and management of the database 145. For example, the DBMS 125 could provide an Application Program Interface (API) through which remote clients (e.g., the client application 165 on the client system 160) can submit requests (e.g., database queries). For example, the client application 165 could submit a database query to retrieve particular values from the database 145. The DBMS 125 could execute the database query against the database 145 to produce a set of query results and could return the set of query results to the client application 165 (e.g., over network 155).

As discussed above, one or more exceptions can be thrown during the execution of a query by the DBMS 125. For example, a query could specify that a division operation should be performed using values within a particular column of a table in the database 145 as the denominator. However, if such a column contains a value of “0”, an exception may be thrown when the DBMS 125 attempts to perform a division by zero operation. Conventionally, such an exception being thrown would result in the DBMS 125 halting the execution of the query, discarding any query results determined thus far during the partial execution of the query and returning an error message to the client application 165.

Generally, the query management component 130 is configured to manage the execution of a query in a manner that accounts for an exception being thrown during execution of the query. In one embodiment, the query management component 130 receives, from a requesting entity, a query for execution against a database. The DBMS 125 could then generate a first query plan for executing the query. Such a query plan may specify a first ordered sequence of operations to be performed in executing the query against the database. The query management component 130 could determine a likelihood that the first query plan, if executed, will result in one or more exceptions being thrown, and the query management component 130 could modify the first query plan based on the determined likelihood. The DBMS 125 could then execute the modified first query plan against the database to produce a set of query results and could return the set of query results to the requesting entity.

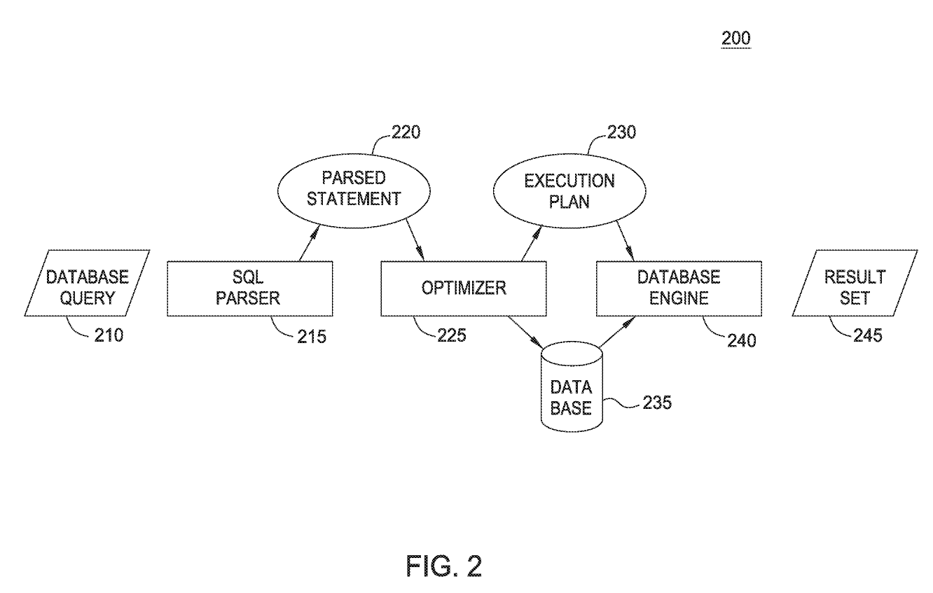

FIG. 2 is a flow diagram for processing a database query at a database management system, according to one embodiment described herein. As shown in the flow diagram 200, the DBMS 125 receives a database query 210 from a requesting entity. In the depicted embodiment, the received query is processed by a Structured Query Language (SQL) parser 215 to generate the parsed statement 220. The parsed statement 220 is passed to an optimizer component 225 for query optimization. As a result of query optimization, an execution plan 230 (also referred to herein as an access plan or a query plan) is generated, often using data such as platform capabilities, query content information, etc., that is stored in database 235. Once generated, the execution plan 230 is forwarded to database engine 240 for execution on the information in database 235. The result of the execution of the database query is typically stored in a result set 245, which can then be returned to the requesting entity. Other components may be incorporated into the DBMS, as may other suitable database management architectures. Other database programming and organizational architectures may also be used consistent with the invention. Therefore, the present is not limited to the particular implementation discussed herein.

In the diagram 200, the database engine 240 could be configured with the query management component 130. The query management component 130 could determine a likelihood that the execution plan 230, if executed against the database 235, will result in one or more exceptions being thrown. The query management component 130 could then modify the execution plan 230 based on the determined likelihood. For example, the query management component 130 could determine that the likelihood exceeds a predefined threshold amount of likelihood, and in response, could modify the execution plan 230 in a manner that reduces the likelihood that an exception will be thrown during execution.

For example, the query management component 130 could modify the execution plan 230 to include a dynamic selection predicate. In such an embodiment, the dynamic selection predicate may include a plurality of selection predicates. In executing the modified execution plan, the database engine 240 could executing a first operation against the database based on a first one of the plurality of selection predicates and, upon determining that the first operation resulted in an error being thrown, could execute a second operation against the database based on a second one of the plurality of selection predicates. Doing so enables the database engine 240 to evaluate multiple selection predicates and to identify at least one of the selection predicates that does not result in an error being thrown. The database engine 240 could then execute the modified query plan against the database 235 to produce the result set 245.

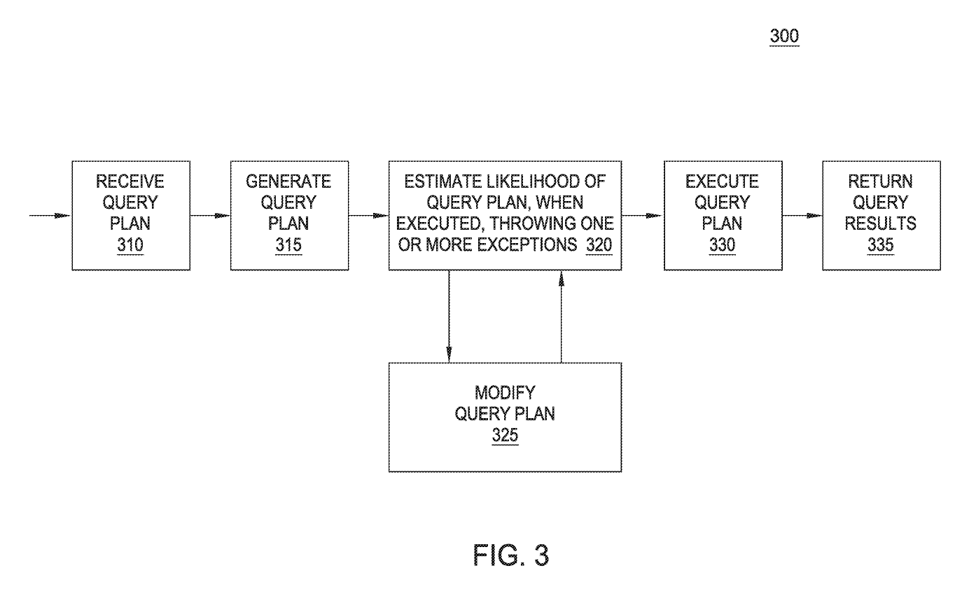

FIG. 3 illustrates a query being processed by a query management component, according to one embodiment described herein. As shown, at block 310, a DBMS (e.g., DBMS 125) receives a query for execution. The DBMS 315 generates a query plan for the received query (block 315). The query management component 130 for the DBMS 315 then estimates a likelihood that the query plan, when executed, will result in one or more exceptions being thrown (block 320). Generally, the query management component 130 can be configured to detect a number of different situations that can result in an exception being thrown during the execution of a query plan. For example, an exception could be generated when data within a decimal field within the database is invalid. As another example, an exception could be generated when a floating point value within the database exceeds the maximum representable value or is less than the minimum representable value. More generally, an operation on any field within the database containing misformed data may result in an exception being thrown during query execution. A non-inclusive list of such examples includes, without limitation, a date value is greater than the maximum allowed value, a date value is less than the minimum allowed value, invalid formatting of the data in a date, time, or timestamp field, invalid data within a date, time, or timestamp field that is not valid, an unexpected null field, and so on.

For example, the query management component 130 could determine one or more database locations (e.g., database table(s), database column(s), etc.) that will be accessed during execution of the query plan, and the query management component 130 could determine a historical rate of error for previous queries against the one or more database locations. The query management component 130 could then use the historical rate of error to estimate the likelihood that the current query plan will result in one or more exceptions being thrown during execution.

As an example, the query management component 130 could determine a historical rate of error for previous queries having substantially similar selection predicates to the current query, and could use such a historical rate of error to determine the likelihood that execution the current query plan will result in an exception being thrown. In one embodiment, the query management component 130 is configured to consider an arithmetic operator used in the query when determining the likelihood an exception will be thrown. As an example, the query management component 130 could determine that a division operator (“/”) is more likely to produce an exception during query execution than a multiplication operator (“*”), e.g., due to situations where a division by 0 occurs. As such, if the current query plan includes a division operator, the query management component 130 could determine that the likelihood an exception will be thrown is relatively higher than if the query did not contain any division operators.

The query management component 130 can also be configured to consider combinations of operators and database locations in estimating the likelihood. For instance, the query management component 130 could analyze historical query execution data and could determine that queries against a particular database table may rarely, if ever, result in exceptions being thrown, regardless of which arithmetic operators are included in the queries. On the other hand, another database location (e.g., a particular column of a particular database table) may have a relatively high historical rate of exceptions being thrown when the query contains a division arithmetic operator, but could otherwise have a relatively low historical rate of exceptions being thrown for queries that do not contain a division arithmetic operator.

In the depicted embodiment, the query management component 130 can then modify the query plan based on the estimated likelihood of an exception being thrown (block 325). For example, the query management component 130 could modify the query plan to include a dynamic selection predicate. Generally, such a dynamic selection predicate could include a plurality of selection predicates, and the DBMS could be configured to iterate through the plurality of selection predicates until a selection predicate is found that does not produce any exceptions. The DBMS then executes the query plan against the database (block 330) and returns the resulting set of query results (block 335).

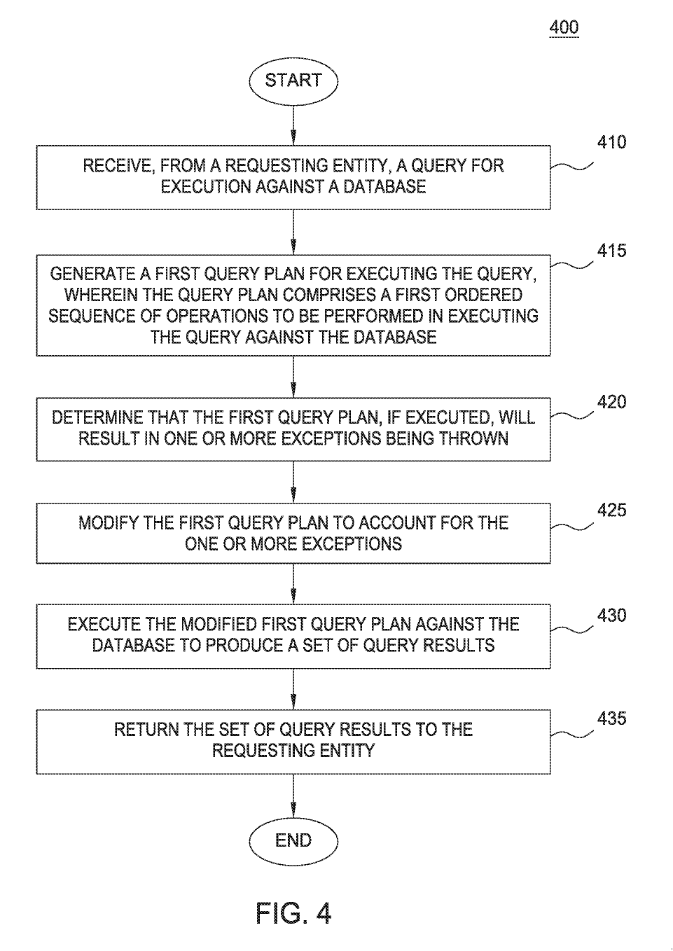

FIG. 4 is a flow diagram illustrating a method of modifying a query to prevent exceptions from being thrown during the execution of a query, according to one embodiment described herein. As shown, the method 400 begins at block 410, where a DBMS (e.g., DBMS 125) receives, from a requesting entity, a query for execution against a database. The DBMS then generates a first query plan for executing the query, where the query plan comprises a first ordered sequence of operations to be performed in executing the query against the database (block 415). The query management component 130 next determines that the first query plan, if executed, will result in one or more exceptions being thrown (block 420). For example, the query management component 130 could determine a denominator value of an arithmetic division operator within the query and could determine that the first query plan will result in an exception being thrown, when at least one row of the database location corresponding to the denominator value contains a value of “0.”

The query management component 130 then modifies the first query plan to account for the one or more exceptions (block 425). For example, in some instances, the requesting entity submitting the query may have indicated that it's permissible to ignore or eliminate erroneous query result rows. As such, the query management component 130 could modify the query to ignore rows that are determined to be erroneous (e.g., in the aforementioned example, rows of the database location having a value of “0”, thereby avoiding any exceptions being thrown and terminating that execution of the query.

As an example, consider the exemplary EMPLOYEE table shown in Table 1.

TABLE 1
EMPLOYEE Table

| Name | Dept | Salary | Bonus |
|---|---|---|---|
| Mark | XYZ | 50000 | 0 |
| Fred | ABC | 10000 | 10000 |
| Sally | ABC | 11000 | 1000 |
| Ann | XYZ | 0 | 0 |

In such an example, the DBMS could receive a query could specify “SELECT Name FROM EMPLOYEE WHERE ((Bonus/Salary)>10%) AND Salary >0.” In submitting such a query, the requesting entity may not believe that any division by 0 errors could occur for the row with a Name of “Ann”. However, in many conventional DBMS systems, there may be no guarantee that predicate the “Salary >0” will be processed before the derived predicate of “((Bonus/Salary)>10%). As such, even though the row having the Name of “Ann” may be excluded from the final set of query results (i.e., because the value for the Salary column does not exceed 0, as required by the “Salary >0” predicate), such a query may still result in an exception being thrown because the derived predicate of “((Bonus/Salary)>10%) may still be processed and result in a division by zero exception being thrown.

As such, the query management component 130 can modify the first query plan to account for the one or more exceptions. For example, the query management component 130 could determine that the derived predicate of “((Bonus/Salary)>10%) contains a division arithmetic operator, and could modify the query plan to ensure that the derived predicate is processed after the “Salary >0” predicate. An example of this is shown below in Pseudo Code 1.

Pseudo Code 1 - Additional Selection
exception_handler(selection_error,
0, _C1_ALL, _C2_ALL, _CTLA_HANDLE_NO_MSG,
“xxxxx”)
for each row i {
if ( row(i) == SELECTED)
keepgoing:
return_row = true;
}
error_saved:
return_now = false;
}
}
disable_handler
selection_error:
if (apply_secondary_selection(row(i))==SELECTED)
goto keepgoing:
}
save_error_info(row(i)) /* Proc to save error row for display at end
of result set. */
goto error_saved:
}
}

Doing so helps to ensure that properly formed queries will execute until completion and will not be terminated during execution due to an exception being thrown. Once the query management component 130 has modified the query plan, the database engine executes the modified query plan against the database to produce a set of query results (block 430). The DBMS returns the set of query results to the requesting entity (block 435), and the method 400 ends.

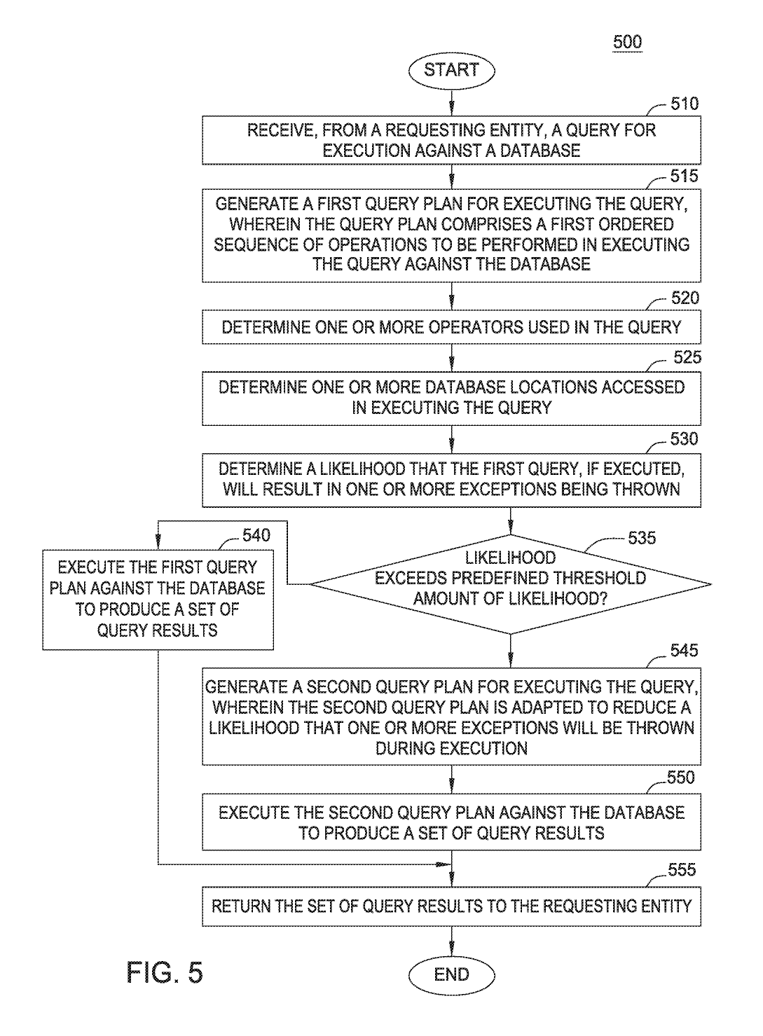

FIG. 5 is a flow diagram illustrating a method of selectively modifying a query to prevent exceptions from being thrown during the execution of a query, according to one embodiment described herein. As shown, the method 500 begins at block 510, where a DBMS receives, from a requesting entity, a query for execution against a database. The DBMS generates a first query plan for executing the query, where the query plan comprises a first ordered sequence of operations to be performed in executing the query (block 515). The query management component 130 determines one or more operators used in the query plan (block 520). For example, the query management component 130 could determine one or more arithmetic operators used in executing the query plan (e.g., a division operator, a multiplication operator, etc.). Additionally, the query management component 130 determines one or more database locations that will be accessed during execution of the query plan (block 525). Such locations could include database tables, columns with database tables, and so on.

The query management component 130 then determines a likelihood that the first query plan, if executed, will result in one or more exceptions being thrown (block 530). In doing so, the query management component 130 can consider the one or more operators and the one or more database locations, as well as historical query error data describing rates of error for previously executed database queries including the same (or substantially similar) operators and database locations, as well as combinations thereof. If the query management component 130 determines that the determined likelihood of an exception being thrown does not exceed a predefined threshold amount of likelihood (block 535), the query management component 130 executes the first query plan against the database to produce a set of query result rows (block 540). The set of query result rows is returned to the requesting entity (block 555) and the method 500 ends.

Alternatively, if at block 535 the query management component 130 determines that the likelihood does exceed the predefined threshold amount of likelihood, the query management component 130 generates a second query plan that is adapted to reduce the likelihood that one or more exceptions will be thrown during execution (block 545). For example, such a second query plan could include a dynamic selection predicate that specifies a plurality of selection predicates, and the database engine could be configured to iterate through the plurality of selection predicates until a selection predicate is found that does not produce an exception. As another example, rather than iterating through the plurality of selection predicates, the query management component 130 could determine, for each of the plurality of selection predicates, a respective likelihood that the query, if modified to include the selection predicate, will result in one or more exceptions being thrown, and could select one of the plurality of selection predicates, having the lowest determined likelihood, for inclusion in the second query plan. More generally, any technique for generating the second query plan can be used, consistent with the functionality described herein. The query management component 130 then executes the second query plan against the database to produce the set of query results (block 550), returns the set of query results to the requesting entity (block 555) and the method 500 ends.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Reference is made herein to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the described aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, microcode, etc.) or an embodiment combining software and hardware aspects that may all generally be referred to herein as a “circuit,” “module” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access applications (e.g., DBMS 125 configured with query management component 130 and hosting the database 145) or related data available in the cloud. For example, the DBMS 125 configured with the query management component 130 could execute on a computing system in the cloud and a client application could submit a query to the DBMS 125 for execution. In such a case, the query management component 130 could receive the query and could determine a likelihood that a query plan for the query, if executed, will result in one or more exceptions being thrown. The query management component 130 could then modify the query plan based on the determined likelihood and could execute the modified query plan against the database to produce a set of query results. Doing so allows a user to submit a query against the database from any computing system attached to a network connected to the cloud (e.g., the Internet), and helps to ensure that the DBMS 125 can better avoid any errors occurring during execution of the query.

While the foregoing is directed to embodiments of the present invention, other and further embodiments of the invention may be devised without departing from the basic scope thereof, and the scope thereof is determined by the claims that follow.

What is claimed is:

1. A method, comprising:
receiving, from a requesting entity, a query for execution against a database;
generating a first query plan for executing the query, wherein the query plan comprises a first ordered sequence of operations to be performed in executing the query against the database;
determining a likelihood that the first query plan, if executed, will result in one or more exceptions being thrown;
dynamically modifying the first query plan based on the determined likelihood;
executing the modified first query plan against the database to produce a set of query results; and
returning the set of query results to the requesting entity.

2. The method of claim 1, wherein determining the likelihood that the first query plan, if executed, will result in one or more exceptions being thrown further comprises:
determining a second likelihood that an access to a first table of the database, during execution of the first query plan, will result in a second one or more exceptions being thrown.

3. The method of claim 1, wherein modifying the first query plan is performed responsive to determining that the determined likelihood exceeds a predefined threshold level of likelihood.

4. The method of claim 1, wherein modifying the first query plan further comprises:
modifying the first query plan to include a dynamic selection predicate, wherein the dynamic selection predicate comprises a plurality of selection predicates, and
wherein executing the modified query plan against the database to produce the set of query results further comprises:
executing a first operation against the database based on a first one of the plurality of selection predicates; and
upon determining that the first operation resulted in an error being thrown, executing a second operation against the database based on a second one of the plurality of selection predicates.

5. The method of claim 1, wherein modifying the first query plan further comprises:
modifying a selection predicate of the query, comprising:
generating a plurality of selection predicates for the query;
determining, for each of the plurality of selection predicates, a respective likelihood that the query, if modified to include the selection predicate, will result in one or more exceptions being thrown; and
selecting one of the plurality of selection predicates, having the lowest determined likelihood.

6. The method of claim 5, wherein modifying the selection predicate of the query further comprises:
generating a respective portion of query results for each of a plurality of selection predicates, based on the received query; and
selecting one of the portions of query results for inclusion in the set of query results, based on a determined measure of error for the portion of query results.

7. The method of claim 1, wherein determining the likelihood that the first query plan, if executed, will result in one or more exceptions being thrown, further comprises:
determining a first selection predicate specified within the query; and
determining, based on historical query execution data, a historical rate of exception generation for historical queries that include the selection predicate.

8. A system, comprising:
one or more computer processors; and
a memory containing computer program code that, when executed by operation of the one or more computer processors, performs an operation comprising:
receiving, from a requesting entity, a query for execution against a database;
generating a first query plan for executing the query, wherein the query plan comprises a first ordered sequence of operations to be performed in executing the query against the database;
determining a likelihood that the first query plan, if executed, will result in one or more exceptions being thrown;
dynamically modifying the first query plan based on the determined likelihood;
executing the modified first query plan against the database to produce a set of query results; and
returning the set of query results to the requesting entity.

9. The system of claim 8, wherein determining the likelihood that the first query plan, if executed, will result in one or more exceptions being thrown further comprises:
determining a second likelihood that an access to a first table of the database, during execution of the first query plan, will result in a second one or more exceptions being thrown.

10. The system of claim 8, wherein modifying the first query plan is performed responsive to determining that the determined likelihood exceeds a predefined threshold level of likelihood.

11. The system of claim 8, wherein modifying the first query plan further comprises:
modifying the first query plan to include a dynamic selection predicate, wherein the dynamic selection predicate comprises a plurality of selection predicates, and
wherein executing the modified query plan against the database to produce the set of query results further comprises:
executing a first operation against the database based on a first one of the plurality of selection predicates; and
upon determining that the first operation resulted in an error being thrown, executing a second operation against the database based on a second one of the plurality of selection predicates.

12. The system of claim 8, wherein modifying the first query plan further comprises:
modifying a selection predicate of the query, comprising:
generating a plurality of selection predicates for the query;
determining, for each of the plurality of selection predicates, a respective likelihood that the query, if modified to include the selection predicate, will result in one or more exceptions being thrown; and
selecting one of the plurality of selection predicates, having the lowest determined likelihood.

13. The system of claim 12, wherein modifying the selection predicate of the query further comprises:
generating a respective portion of query results for each of a plurality of selection predicates, based on the received query; and
selecting one of the portions of query results for inclusion in the set of query results, based on a determined measure of error for the portion of query results.

14. The system of claim 8, wherein determining the likelihood that the first query plan, if executed, will result in one or more exceptions being thrown, further comprises:
determining a first selection predicate specified within the query; and
determining, based on historical query execution data, a historical rate of exception generation for historical queries that include the selection predicate.

15. A computer-readable storage medium containing computer program code that, when executed by operation of one or more computer processors, performs an operation comprising:
receiving, from a requesting entity, a query for execution against a database;
generating a first query plan for executing the query, wherein the query plan comprises a first ordered sequence of operations to be performed in executing the query against the database;
determining a likelihood that the first query plan, if executed, will result in one or more exceptions being thrown;
dynamically modifying the first query plan based on the determined likelihood;
executing the modified first query plan against the database to produce a set of query results; and
returning the set of query results to the requesting entity.

16. The computer-readable storage medium of claim 15, wherein determining the likelihood that the first query plan, if executed, will result in one or more exceptions being thrown further comprises:
determining a second likelihood that an access to a first table of the database, during execution of the first query plan, will result in a second one or more exceptions being thrown.

17. The computer-readable storage medium of claim 15, wherein modifying the first query plan is performed responsive to determining that the determined likelihood exceeds a predefined threshold level of likelihood.

18. The computer-readable storage medium of claim 15, wherein modifying the first query plan further comprises:
modifying the first query plan to include a dynamic selection predicate, wherein the dynamic selection predicate comprises a plurality of selection predicates, and
wherein executing the modified query plan against the database to produce the set of query results further comprises:
executing a first operation against the database based on a first one of the plurality of selection predicates; and
upon determining that the first operation resulted in an error being thrown, executing a second operation against the database based on a second one of the plurality of selection predicates.

19. The computer-readable storage medium of claim 15, wherein modifying the first query plan further comprises:
modifying a selection predicate of the query, comprising:
generating a plurality of selection predicates for the query;
determining, for each of the plurality of selection predicates, a respective likelihood that the query, if modified to include the selection predicate, will result in one or more exceptions being thrown; and
selecting one of the plurality of selection predicates, having the lowest determined likelihood.

20. The computer-readable storage medium of claim 15, wherein determining the likelihood that the first query plan, if executed, will result in one or more exceptions being thrown, further comprises:
determining a first selection predicate specified within the query; and
determining, based on historical query execution data, a historical rate of exception generation for historical queries that include the selection predicate.
